(19) United States
(12) Patent Application Publication
(10) Pub. No.: US 2007/0114300 A1
(43) Pub. Date: May 24, 2007

(54) Automotive electric fan system with a liquid misting unit

(76) Inventor: Michael Philip Green, Pleasant Hill, CA (US)

Correspondence Address: SHELDUST INC., 5236 PACHECO BLVD, PACHECO, CA, 94553, US

(21) Appl. No.: 11/282,394

(22) Filed: Nov. 18, 2005

(51) Int. Cl. B05B 7/16; B05B 1/24

(52) U.S. Cl. 239/128; 239/130; 239/133

(57) ABSTRACT

The present invention relates to automotive radiator type cooling systems and the use of electric powered cooling fan incorporating a liquid misting unit consisting of a liquid holding tank, a spray nozzle or a series of nozzles, anti siphon flow valve, an electric liquid pump, heat sensor to automatically turn on the fan and misting unit or a manual on the off switch. When incorporating a liquid misting prior to the air entering the radiator allows cooler air to flow through the radiator making the radiator more efficient at cooling the vehicle's engine.

### BACK GROUND OF THE INVENTION

The present invention relates to an automotive engine liquid cooling system and the use of a electric cooling fan incorporating a liquid misting unit for additional cooling to a vehicles heat exchanger or what is more commonly referred to as a radiator. All radiators rely on a source of air flowing passing by a series of cooling passages and cooling fins to transfer heat out of the system which is generated by the vehicle's engine. To increase the vehicle's cooling system efficiency the use of a fan either mechanical or electric is used to generate more air flow through the radiator. When a vehicle is under a load, such as traversing steep grades or pulling a heavy trailer the engine produces more heat which in turn can create unstable liquid cooling temperatures. If the temperature rises to its boiling point a loss of cooling liquid can occur, some types of cooling liquids are hazardous to the environment and the loss of the cooling liquid will cause serious damage to the vehicle's engine. When introducing a liquid mist prior to the air flow entering into the radiator a denser cooler air mass is created and is either pushed or pulled into the radiator by the fan, increasing the cooling efficiency of both the fan and the radiator.

### DESCRIPTION OF RELATED ART

An automotive cooling system is comprised of a cooling liquid circulated through a heat exchanger, (radiator) by a liquid pump linked together by a series of hoses which supply a passage to the vehicle's engine. As the cooling liquid circulates through the internal passages of the engine, heat is transferred from the engine to the cooling liquid which is then pumped back to the heat exchanger. The heat exchanger relies on air flow traveling threw the heat exchanger's cooling tubes and air fins to cool the liquid before re-entering back to the engine. This air flow is created either by a cooling fan when the vehicle is stationary with its engine running or when the vehicle is moving and air flow is guided and flows threw the heat exchanger. When a water mist is introduced into the air flow prior to entering the heat exchanger a decrease in temperature can be achieved causing an additional cooling effect for the vehicles engine.

### SUMMARY OF THE INVENTION

The present invention relates to automotive cooling fan and the induction of a liquid mist introduced to the air flow by a misting jet or a series of misting jets located on the electric fan housing and allowing the liquid to mix with the incoming air flow prior to the air flow entering into the vehicles heat exchanger. Most vehicles rely on air flow through the heat exchanger cooling tubes and fins to cool the cooling liquid that keeps the vehicle's engine from overheating. Adequacy air flow is supplied either by a cooling fan or movement of the vehicle which directs air through the heat exchanger. Most vehicles require either a mechanical driven or an electric powered fan to generate proper air flow when the vehicle is running but stationary. When a vehicle is under load such as pulling a long steep hill or pulling a trailer additional heat is created by the engine which in turns causes the cooling liquid to heat up. Under these types of circumstances extended load time can cause a vehicle to overheat and have a roadside breakdown, loss of the cooling liquid which some types can be a hazardous to the environment and under extreme circumstances severe engine damage can result. Misting the incoming air with a liquid decreases the incoming air temperature to the heat exchanger making it more efficient at cooling when the vehicle is under load and allows the vehicle to operate under load longer without overheating.

### BRIEF DESCRIPTION OF THE DRAWINGS

FIG. 1 is a view of a heat exchanger (automotive radiator) and an attaching electric fan and fan housing.

FIG. 2 is a view of an incorporated misting unit manufactured into the fan housing of a single fan system. Illustrated is the liquid holding tank with a filler neck and cap, electric liquid pump, anti siphon valve, misting jet liquid manifold and the misting jets.

FIG. 3 is a view of a universal misting unit which can be attached to a single fan system. Illustrated is the liquid holding tank with filler neck and cap, electric liquid pump, anti siphon valve, misting jet liquid manifold and the misting jets.

FIG. 4 is a view of a universal misting unit which can be attached to a dual fan system. Illustrated is the liquid holding tank with a filler neck and cap, electric liquid pump, anti siphon valve, liquid passage tubes, misting jet liquid manifolds, and the misting jets.

FIG. 5 is a view of an incorporated misting unit manufactured into the fan housing of a dual fan system. Illustrated is the liquid holding tank with a filler neck and cap, electric liquid pump, anti siphon valve, liquid passage tubes, misting jet liquid manifolds, and the misting jets.

FIG. 6 is a side view of the electric fan housing with an intergraded liquid holding tank with filler neck and cap, electric liquid pump, anti siphon valve, liquid passage tubes, misting jet liquid manifold and fan.

FIG.7 shows a side view of the electric fan housing with an intergraded liquid holding tank with filler neck and cap, electric liquid pump, anti siphon valve, liquid passage tubes and a series of misting jets built into the fan hub.

### DETAILED DESCRIPTION OF THE INVENTION

In accordance with the present invention, an automotive electric fan is used to supply air flow to the vehicles heat exchanger, (radiator), when incorporating a liquid misting unit to the cooling fan housing enables an additional cooling effect which allows the vehicle's engine to operate at cooler temperatures when under extreme loads or when additional cooling may be required.

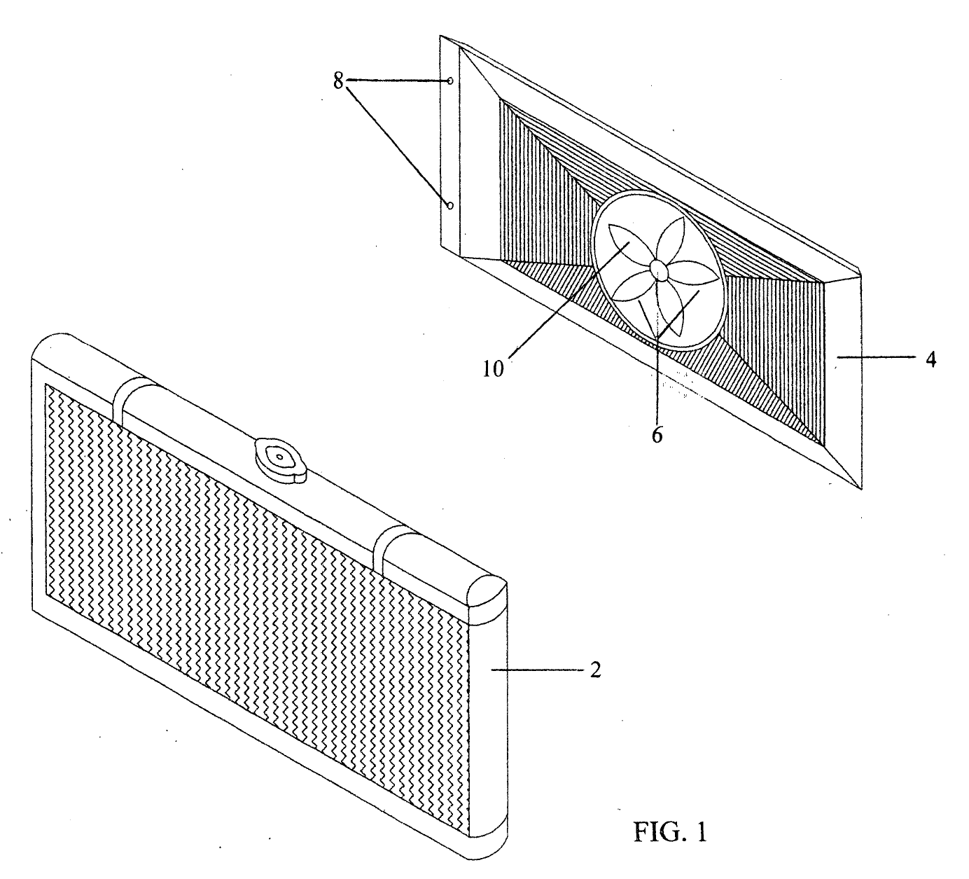

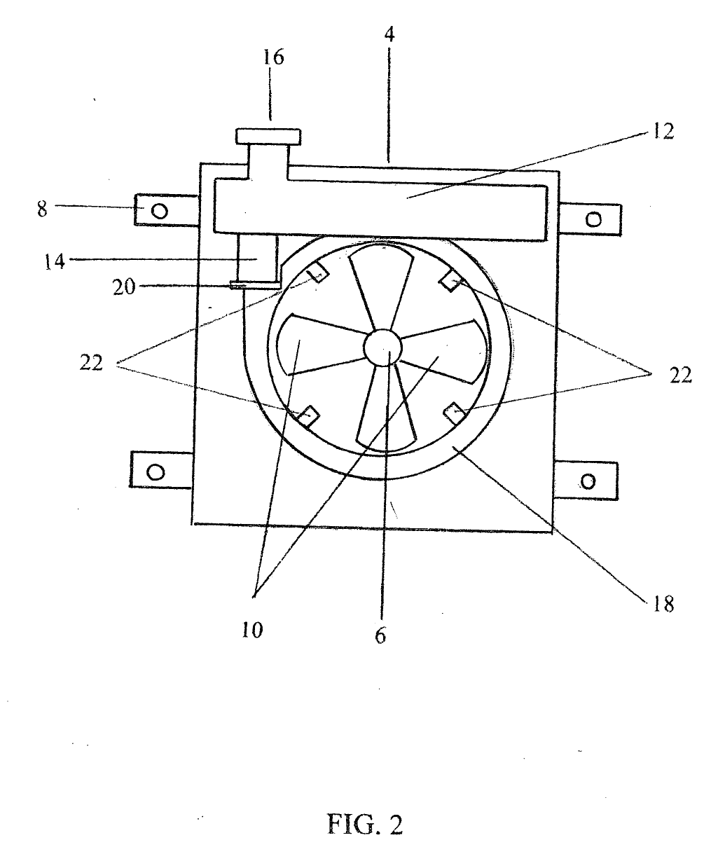

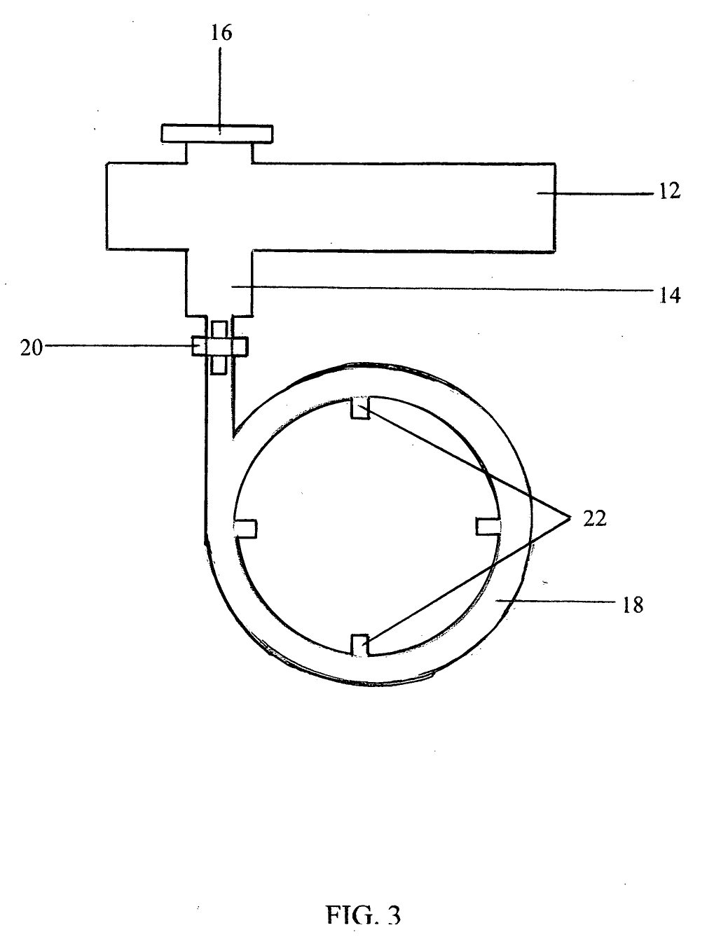

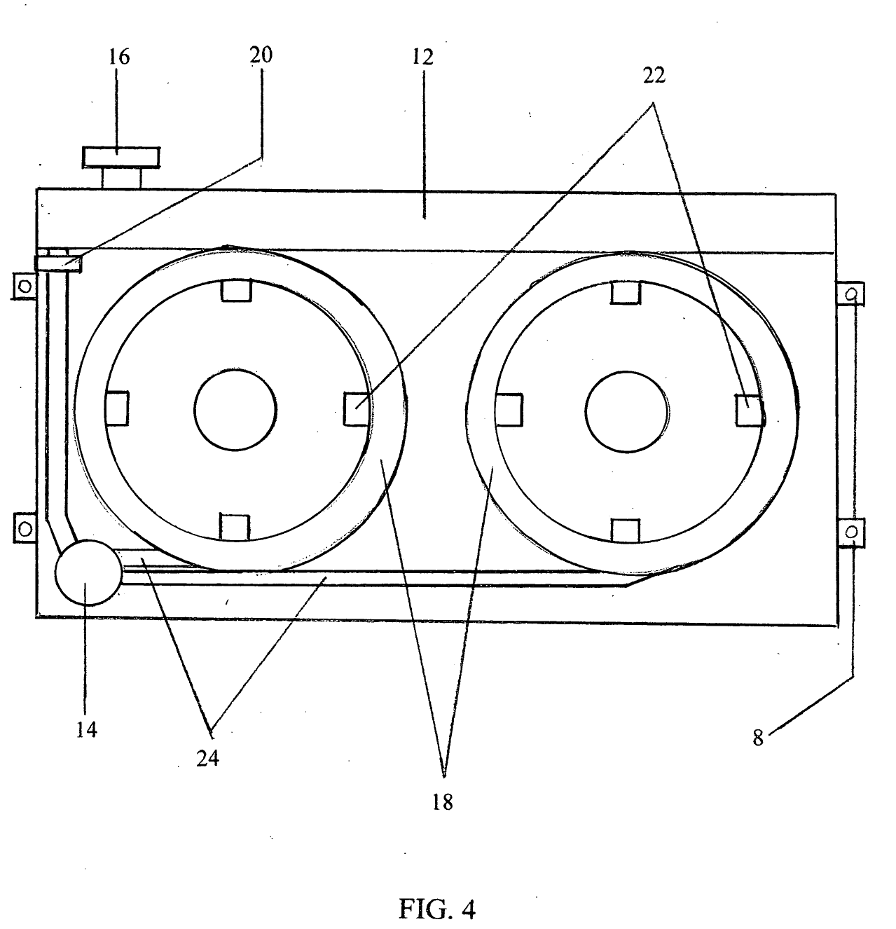

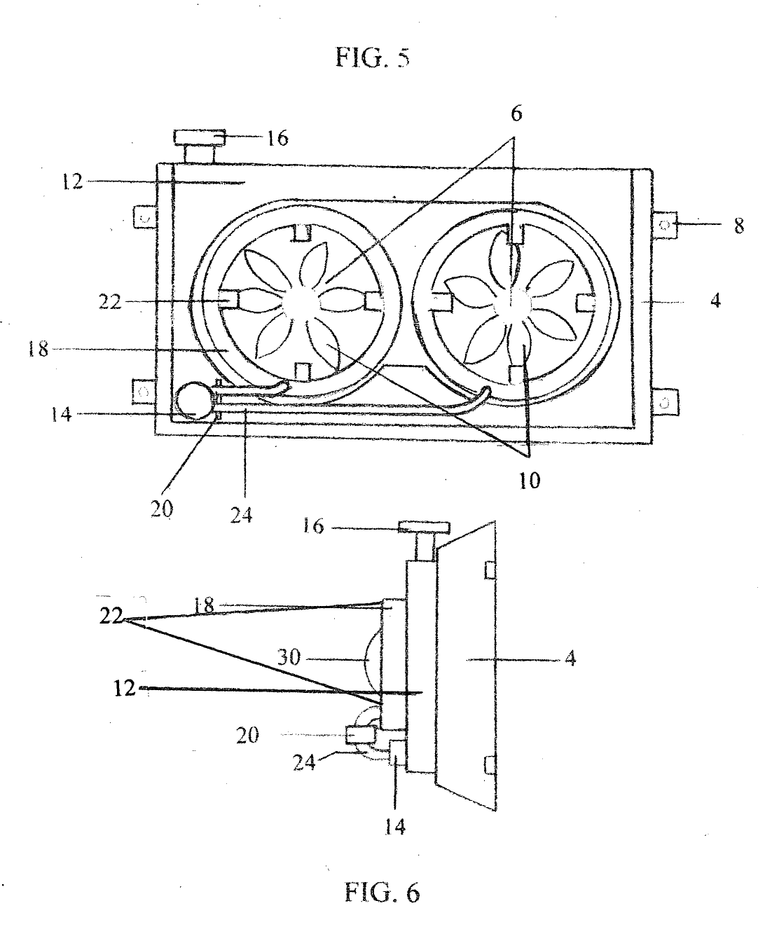

An automotive electric fan system integrates a protective cover or frame work around the fan to protect the fan blades and is used for mounting purposes. This structure is more commonly referred to as the fan housing. The present invention illustrated in FIG. 1 shows the electric fan 6 mounted onto the fan housing 4 which provides protection for the fan blades 10. The fan housing incorporates mounting brackets 8 which enables the fan housing to be mounted close to or against the heat exchanger 2 or to the vehicle. FIG. 2 shows the electric fan 6 mounted onto the fan housing 4 which provides protection for the fan blades 10. The fan housing incorporates mounting brackets 8 which enables the fan housing to be mounted to the heat exchanger or the vehicle. This illustration shows an intergraded liquid misting unit manufactured into or onto the fan housing 4. The liquid holding tank 12 used to house the misting liquid and integrates a filler neck and cap 16 which is used for filling and sealing the liquid in the holding tank. The holding tank 12 incorporates an electric liquid pump 14 for the delivery of liquid through the inline anti siphon valve 20 which only allows the liquid to flow when under pumping pressure from the liquid pump. The flow continues to the misting jet manifold 18 which directs the liquid to the misting jet or jets 22. FIG. 3 shows the present invention as a universal unit which can be installed on the most common manufactured automotive single electric fan systems. This universal unit incorporates a liquid holding tank 12 for housing the liquid, a filler neck and cap 16 to fill and seal the liquid inside the holding tank, a integrated electric liquid pump 14, which delivers the liquid to the inline anti siphon valve 20 and allows the liquid to flow only under pressure from the liquid pump to the misting jet manifold 18 which delivers the misting liquid to the misting jet 22. FIG. 4 shows the present invention as a universal unit which can be installed on the most common manufactured automotive dual electric fans systems. This universal unit incorporates a liquid holding tank 12 for housing the liquid, a filler neck and cap 16 to fill and seal the liquid inside the holding tank, a integrated electric liquid pump 14, which delivers the liquid to the inline anti siphon valve 20 which allows the liquid to flow only under pressure from the liquid pump to the misting jet manifold 18 which delivers the misting liquid to the misting jets 22. FIG. 5 shows the electric fan 6 mounted into the fan housing 4 which provides protection for the fan blades 10. The fan housing incorporates mounting brackets 8 which enables the fan housing to be mounted to the heat exchanger or to the vehicle. This illustration shows an intergraded liquid misting unit manufactured into or onto the fan housing 4. The liquid holding tank 12 used to house the misting liquid and integrates a filler neck and cap 16 which is used for filling and sealing the liquid in the holding tank. The holding tank 12 incorporates an electric liquid pump 14 for the delivery of liquid through the inline anti siphon valve 20 which only allows the liquid to flow when under pumping pressure from the liquid pump. The flow continues to the misting jet manifold 18 which directs the liquid to the misting jets 22. FIG. 6 is a side view of the present invention and illustrates incorporating a misting unit during manufacturing to the fan housing or frame work 4 which provides protection for the fan blades 10. The liquid holding tank 12, holds the misting liquid. The intergraded filler neck and cap 16 is used for filling and sealing the liquid in the holding tank. The holding tank incorporates an electric liquid pump 14 to provide the misting liquid to the inline anti siphon valve 20 which delivers the liquid only when under pressure from the liquid pump, the liquid continues to flow through a series of passage tubes 24 to the misting jet manifolds 18 which distributes the misting liquid to the misting jets 22.

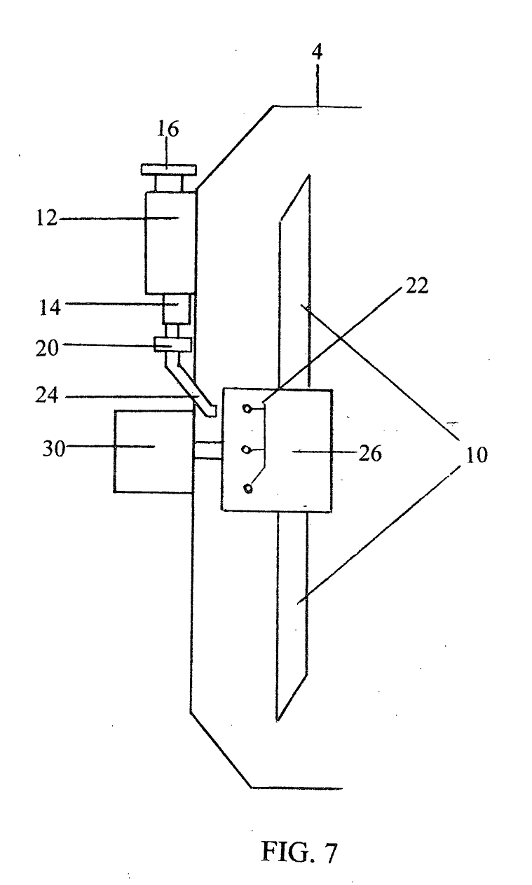

FIG. 7 illustrates a side view of the present invention which incorporates a liquid holding tank 12, an intergraded filler neck and cap 16 for installing and sealing the liquid inside the holding tank, electric liquid pump 14 which pumps the liquid through the system to the anti siphon valve 20 which only allows the liquid to flow under pressure from the electric liquid pump 14, liquid passage tube 24 which delivers a stream of misting liquid to the misting jet or jets 22 located in the hub of the fan 26. The electric fan motor 30 turns the fan blades 10 and under fan blade rotation the cooling liquid is forced to the outside portion of the fan hub 26 and into the misting jets 22.

While various modifications, changes and alternatives are suggestible to one skilled in the art based on the descriptions set forth above, the invention is to be given the broadest interpretation based on the scope of the appended claims.

What is claimed is:

1. An automotive electric fan is used to promote air flow to the vehicle's heat exchanger, (radiator) to help cool the cooling liquid passages and cooling fins. The incorporation of a liquid misting unit enhances the cooling effect of both the electric fan and the heat exchanger.

2. An automotive electric fan incorporates a fan housing or frame work for the purpose of supporting the fan's electric motor or motors and mounting of the unit to the heat exchanger or to the vehicle. The fan housing or frame work can incorporate a liquid holding tank, a liquid pump, anti siphon valve, a liquid passage tube to a liquid manifold which directs the misting liquid to the misting jet or a series of misting jets.

3. An automotive electric single, dual or multiple fan system can be manufactured to incorporate into or onto the fan housing or housings a liquid holding tank, a liquid pump, anti siphon valve, a liquid passage tube or tubes, a liquid manifold or manifolds which directs the misting liquid to the misting jet or a series of misting jets.

4. A common manufactured single, dual or multiple automotive electric fan system can be modified to except a universal misting unit consisting of a liquid holding tank, electric liquid pump, anti siphon valve, a liquid passage tube or tubes connected to a liquid manifold or liquid manifolds which directs the misting liquid to the misting jet or series of misting jets.

5. An internal passage ways for liquid flow can be installed during the fan hub and blade manufacturing allowing the misting liquid to travel through the interior of the fan assembly and being distributed to the heat exchanger at any point from the fan hub or fan blade.

6. A common single on and off switch mounted inside the cabin of the vehicle can be used to switch on the electric fan or fans and the liquid misting unit or units at the same time. Two single switches can be used to switch on individually the electric fan or fans and the liquid misting unit or units. A light can be installed on the switch holder indicting to the user when the misting unit in on or when it has automatically turned on. This light can automatically turn off once the misting unit has shut down. A heat sensing sensor unit install in the engine's cooling liquid can be electrically wire to the fan or fans and the misting unit or units and can be used to automatically turn on or shut off the individual units. A two stage heat sensing sensor unit located in the engine's cooling liquid can have two temperature settings. It can electrically turn on the fan or fans at one engine temperature as well as shut them off and as the temperature increases it can then turn on or shut off the misting unit or units. Any type of heat sensing sensor or heat probe system with or without an adjustable thermostat can be electronically wire to the fan and misting systems to turn the systems on or off at the same time or can be turned on at preset temperature range.

7. A misting liquid level indictor can be installed inside or on the outside of the liquid holding tank indicting the liquid level inside the holding tank. The holding tank can also be electronically wired with an indicting level light installed inside the vehicle's cabin letting the user know when the liquid level is low and the liquid level needs to be re-filled. A sensing unit can be installed into or onto the liquid holding tank and automatically shut the liquid misting unit off to avoid causing damage to the electric liquid pump once the holding tank has ran out of misting liquid.

8. The liquid jet manifold can be configured in any series of ways, it can be semi or fill circle around the fan unit or units or a straight misting bar could be used for the cooling affect. The jet manifold could be eliminated and the uses of a liquid passage tube with a single or a series misting jets could be used for the cooling affect.

9. The anti siphon valve could be eliminated if the liquid holding tank were mounted below the misting jet or jets.

10. The misting unit or units do not have to be mounted onto the electric fan housing. The misting unit could have a remote liquid holding tank or tanks, a remote electric pump or pumps, a remote anti siphon valve or valves and a remote liquid misting manifold or manifolds. The misting jet or jets could be placed any distance ahead of the vehicles liquid or air heat exchanger.

11. The misting unit can be used for air heat exchangers used for the purpose of cooling the flow of air to a liquid cooler such as a transmission, oil and fuel cooler or the misting system can be used for cooling the air flow to a vehicle's air heat exchanger commonly known as an intercooler or after cooler for the vehicle's fuel and air intake system. The misting unit can be installed onto or into a vehicle's air conditioning condenser thus increasing the efficiency of cold air out put of the vehicle's air conditioning system.

12. A collection liquid tank which would collect and recycle the excess misting liquid which could be transferred back to the main liquid holding tank. Or any type of moisture absorbing material positioned to collect excess misting liquid which would continue the evaporation cooling process after the liquid misting pump has been shut off.
